(19) United States
(12) Patent Application Publication
(10) Pub. No.: US 2018/0092494 A1
(43) Pub. Date: Apr. 5, 2018

(54) INSULATED SKIRT FOR CHAFING DISH

(71) Applicant: H&H HEATING SOURCES, LLC, Newburgh, IN (US)

(72) Inventors: Logan Hayford, Newburgh, IN (US); Austin J. Hale, Evansville, IN (US); David Treptow, Vista, CA (US); Jeff Imray, Vista, CA (US)

(73) Assignee: H&H Heating Sources, LLC, Newburgh, IN (US)

(21) Appl. No.: 15/284,724

(22) Filed: Oct. 4, 2016

(51) Int. Cl. A47J 41/00

(52) U.S. Cl. CPC A47J 41/0038; A47J 41/0061

(57) ABSTRACT

An insulated skirt for a chafing dish having an enclosed insulated region surrounding the frame of the chafing dish. The skirt is a single continuous unit that wraps around the frame without openings thereby providing improved heat retention characteristics. Because the skirt is designed for use with flameless chafing dishes, there is no need to allow air to enter the space around the frame beneath the water pan, resulting in improved heat retention. The insulated skirt generally includes an outer skirt member configured to wrap around and substantially enclose the chafing dish frame. An inner skirt member is attached to an upper edge of the outer skirt member and wraps inside the chafing dish frame such that the area where the two join engages the upper frame member of the chafing dish frame. Mechanical fastening means, such as fabric hook and loop fasteners are also provided for securing the skirt to the upper frame member of the chafing dish.

### BACKGROUND OF THE INVENTION

### Field of the Invention

The present invention relates to a skirt for a chafing dish. More specifically, the present invention relates to a chafing dish skirt that can be quickly and easily placed around a chafing dish frame and that provides an insulation layer and wind protection for promoting heat retention.

### Description of the Related Art

Prior art chafing dish skirts have been primarily associated with the need to shield open flame heat sources located in the chafing dish frame below a water pan from wind. A primary concern with these types of skirts is ensuring that the skirt material does not catch fire. As such, most prior art chafing dish skirts have been focused on flame resistant and/or flame retardant materials, as well as using either stiff or weighted fabrics to prevent the skirt material from coming into contact with the flame. Furthermore, because the prior art chafing dish skirts have been associated with open flame heat sourced chafing dishes, there has been a need to allow airflow into the space occupied by the open flame heat source thereby limiting the ability of the skirts to provide effective heat retention.

With the recent invention of a flameless non-electric chafing dish, which is the subject matter of applicant's co-pending patent application Ser. No. 15/284,651 filed on Oct. 4, 2016, there is a need for a chafing dish skirt that can provide improved heat retention characteristics without the worries associated with the skirt catching fire or the need to allow access to air to keep the flame burning.

### SUMMARY OF THE INVENTION

It is therefore an object of the present invention to provide a chafing dish skirt that provides improved heat retention characteristics.

It is also an object of the invention to provide a chafing dish skirt that can be quickly and easily installed on the frame of a chafing dish.

A further object of the invention is to provide a chafing dish skirt that can be quickly and easily adapted to use on chafing dishes of differing heights.

The present invention meets these objects by providing an insulated skirt for a chafing dish that has an enclosed insulated region surrounding the frame of the chafing dish. The skirt is a single continuous unit, with or without seams, that wraps around the frame without the need for ventilation openings thereby providing improved heat retention characteristics. Because the skirt is designed for use with flameless chafing dishes, there is no need to allow air to enter the space around the frame beneath the water pan, resulting in improved heat retention.

According to one presently preferred embodiment of the invention, there is provided an insulated chafing dish skirt for removably attaching to a chafing dish frame to help retain heat within the chafing dish. The insulated chafing dish skirt includes a first skirt member comprising one or more pieces of fabric configured to wrap around and substantially enclose the chafing dish frame. The fabric skirt member includes an upper edge and a lower edge. A second skirt member comprising one or more pieces of fabric having a lower edge attached to the upper edge of the first skirt member is also provided. When the skirt is placed on the chafing dish frame, the area where the upper edge of the first skirt and lower edge of the second skirt is joined engages an upper frame member of the chafing dish frame. Mechanical fastening means are also provided for securing the skirt to the upper frame member of the chafing dish. Means for adjusting the height of the skirt relative to the chafing dish frame are also provided. The insulated chafing dish skirt may further include a second insulating layer of material applied over the fabric of the first skirt member to provide improved heat retention. The first skirt member and the second skirt member, according to one preferred embodiment, consists of four corresponding pieces of fabric each to form a dish skirt that is substantially rectangular in shape. One or more openings may be provided in the first skirt member for permitting access to handles on the chafing dish frame.

The mechanical fastening means may includes a plurality of fabric hook and loop fasteners associated with the first skirt member and the second skirt member for removably connecting the first skirt member to the second skirt member to secure the skirt to the chafing dish frame. The plurality of fabric hook and loop fasteners may further include a plurality of fabric hook fasteners attached to the second skirt member and a corresponding plurality of fabric loop fasteners attached to an inner surface of the first skirt member in a position to releasably engage the plurality of fabric hook members. The height of the skirt can be varied depending upon the points at which the plurality of hook fasteners engage the plurality of loop fasteners. These and other objects, features and advantages of the present invention will become apparent from a review of the following drawings and detailed description of the preferred embodiments of the invention.

### BRIEF DESCRIPTION OF THE DRAWINGS

The present invention can best be understood in connection with the accompanying drawings. It is noted that the invention is not limited to the precise embodiments shown in the drawings, in which:

FIG. 1 is a bottom perspective view of an insulated skirt for a chafing dish according to a preferred embodiment of the present invention.

FIG. 2 is a front perspective view of the insulated skirt shown in FIG. 1, with the skirt shown suspended above a chafing dish frame.

FIG. 3 is an exploded perspective view the skirt shown in FIG. 1 shown in conjunction with a flameless non-electric chafing dish.

### DETAILED DESCRIPTION OF THE INVENTION

For purposes of promoting and understanding of the principles of the invention, reference will now be made to the embodiments illustrated in the drawings and specific language will be used to describe the same. It will nevertheless be understood that no limitation of the scope of the invention is thereby intended. The invention includes any alterations and further modifications in the illustrated devices and described methods and further applications of the principles of the invention that would normally occur to one skilled in the art to which the invention relates.

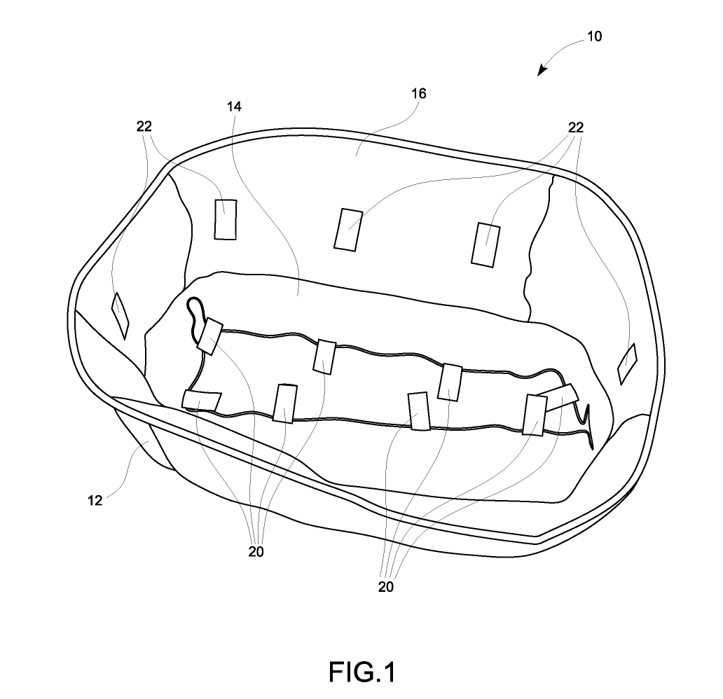

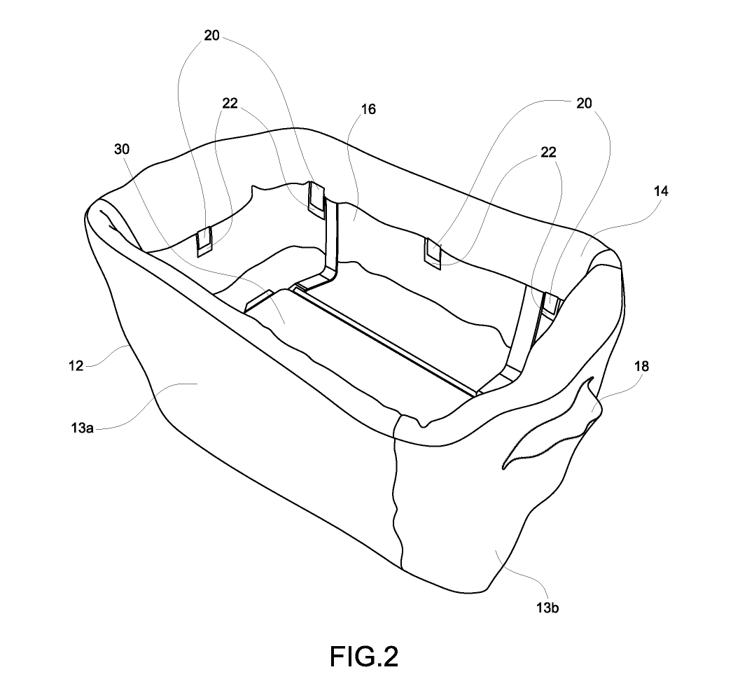

As best shown in FIG. 1, one presently preferred embodiment of the invention comprises an insulated skirt 10 for a chafing dish having a first skirt member 12 and a second skirt member 14. Each of the first skirt member 12 and second skirt member 14 form a continuous skirt that wraps all the way around and completely encloses the chafing dish frame 30 as shown in FIG. 2. The first and second skirt members 12, 14 may be formed of a single continuous piece of fabric or material, or, as shown in FIG. 2, they may consist of two pieces of material seamed together. The first skirt member 12 is of a length that essentially corresponds to the height of the chafing dish frame 30. It may be comprised of a continuous piece of fabric, or two or more sections of fabric, and, more particularly as shown in the drawings, as four sections of fabric 13a, 13b, 13c, 13d sewn together and assembled such that the four locations where the four sections of fabric 13a, 13b, 13c, 13d are joined correspond to the corners of the upper frame 32 of the chafing dish frame 30.

According to the preferred embodiment shown in the drawings, an optional additional layer of insulating material 16 may be provided on a surface of the first skirt member 12 to provide improved heat retention within the area beneath the chafing dish frame 30 that is enclosed by the skirt 10. As shown in FIG. 1, the insulating layer is preferably provided inside the first skirt member 12, although other configurations are possible and anticipated.

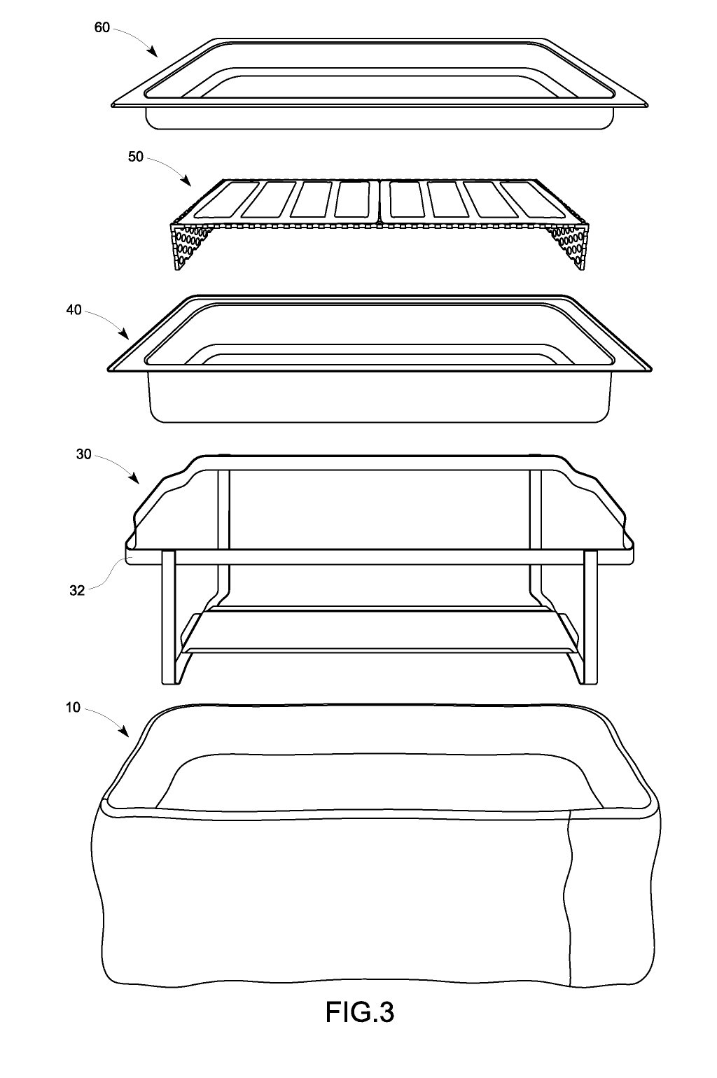

The second skirt member 14 is attached to and extends from the upper end of the first skirt member 12 and is preferably formed from the same or a similar material as the outer skirt member 12. As best shown in FIG. 2 and FIG. 3, the insulated skirt 10 hangs from the upper frame 32 of the chafing dish frame 30. The skirt 10 hangs from the upper frame at or near the point where the first skirt member 12 and second skirt member 14 are joined. Openings 18 may be provided in the surface of the first skirt member 12 to permit access to parts of the chafing dish frame 30, such as handles 34. The first skirt member 12 and second skirt member 14 may be formed of any fabric or material including, but not limited to cotton, cotton-blend fabric, vinyl, leather, nylon, etc. The surface of the fabric may be plain, or may be decorated with any design that can be incorporated into fabric such as a camouflage pattern or art design as shown in the drawings. In addition, artwork such as logos or designs may be displayed on the flat surfaces of the first skirt member 12 for purposes of advertising and the like.

The skirt 10 is removably secured onto the chafing dish frame 30 by mechanical fastening means. As shown in the drawings, fabric hook and loop fasteners are used. A plurality of fabric hook fasteners 20 extend from the free end of the second skirt member 14. Corresponding fabric loop fasteners 22 are provided on the inner surface of the first skirt member 12 to releasably engage the fabric hook fasteners 20 to quickly and easily secure the skirt 10 in place on the frame 30.

The length of skirt 10 that hangs over on the outside of the frame 30 can be adjusted to accommodate frames of various heights. The location where hook fasteners 20 engage loop fasteners 22 can be varied to accomplish this. For example, where a taller frame is used, the hook fastener 20 would engage the loop fastener 22 at a location nearer to the point where the first and second skirt members are joined thereby shifting the point where the skirt 10 rests on the frame 30 from the point where the first and second skirt members meet, to a location somewhere on the second skirt member 14. Conversely, where a shorter frame is used, the hook fastener 20 would engage the loop fastener 22 at a location further from the point where the first and second skirt members are joined thereby shifting the point where the skirt 10 rests on the frame 30 from the point where the first and second skirt members meet to a location somewhere on the first skirt member 12.

As best shown in FIG. 3, the skirt 10 is fitted over and surrounds the chafing dish frame 30. A lower (water) pan 40 then rests on the portion of the skirt 10 supported by the upper frame 32 of the chafing dish frame 30. An improved heat source 50, as described in co-pending U.S. patent application Ser. No. 15/284,65 is placed in the lower pan 40. A food pan 60 nests within the lower pan 40 such that the improved heat source comes into contact with the bottom of the food pan 18 to effectively and efficiently transfer heat to the food in the food pan 18 to keep it warm.

This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

We claim:

1. An insulated chafing dish skirt for removably attaching to a chafing dish frame to help retain heat within the chafing dish comprising:
a first skirt member comprising one or more pieces of fabric configured to wrap around and substantially enclose the chafing dish frame, said fabric skirt member having an upper edge and a lower edge;
a second skirt member comprising one or more pieces of fabric having a lower edge attached to the upper edge of the first skirt member such that when placed on the chafing dish frame, the area where the upper edge of the first skirt and lower edge of the second skirt is joined engages an upper frame member of the chafing dish frame; and
mechanical fastening means for securing the skirt to the upper frame member of the chafing dish.

2. The insulated chafing dish skirt of claim 1, further comprising a second insulating layer of material applied over the fabric of the first skirt member.

3. The insulated chafing dish skirt of claim 1 wherein said first skirt member consists of four pieces of fabric and the second skirt member consists of four corresponding pieces of fabric that form a dish skirt that is substantially rectangular in shape.

4. The insulated chafing dish skirt of claim 1 wherein said first skirt member includes one or more openings therein for permitting access to handles on the chafing dish frame.

5. The insulated chafing dish skirt of claim 1 wherein said mechanical fastening means includes a plurality of fabric hook and loop fasteners associated with the first skirt member and the second skirt member for removably connecting the first skirt member to the second skirt member to secure the skirt to the chafing dish frame.

6. The insulated chafing dish skirt according to claim 5 wherein said plurality of fabric hook and loop fasteners comprises a plurality of fabric hook fasteners attached to the second skirt member and a corresponding plurality of fabric loop fasteners attached to an inner surface of the first skirt member in a position to releasably engage the plurality of fabric hook members.

7. The insulated chafing dish skirt according to claim 6 wherein the height of the skirt can be varied depending upon the points at which the plurality of hook fasteners engage the plurality of loop fasteners.

8. The insulated chafing dish skirt according to claim 1 further comprising means for adjusting the height of the skirt relative to the chafing dish frame.
